(19) United States
(12) Patent Application Publication
(10) Pub. No.: US 2026/0212867 A1
(43) Pub. Date: Jul. 23, 2026

(54) INFORMATION PROCESSING APPARATUS

(71) Applicant: NEC Corporation, Tokyo (JP)

(72) Inventors: Yuto MATSUNAGA, Tokyo (JP); Kazuya Kakizaki, Tokyo (JP); Taiki Miyagawa, Tokyo (JP); Ryo Furukawa, Tokyo (JP); Toshinori Araki, Tokyo (JP)

(73) Assignee: NEC Corporation, Tokyo (JP)

(21) Appl. No.: 19/426,313

(22) Filed: Dec. 19, 2025

(30) Foreign Application Priority Data
Jan. 22, 2025 (JP) 2025-009197

(51) Int. Cl. G10L 17/10; G10L 17/04; G10L 17/26

(52) U.S. Cl. CPC G10L 17/10; G10L 17/04; G10L 17/26

(57) ABSTRACT

An information processing apparatus of the present disclosure includes an input unit that inputs, to a model that analyzes data, input data including information based on target data and information based on an identification result of the target data by an identification model, and an output unit that outputs interpretation data representing an interpretation of an identification result corresponding to the input data, from the model in a plurality of data formats.

### INCORPORATION BY REFERENCE

This application is based upon and claims the benefit of priority from Japanese patent application No. 2025-009197, filed on Jan. 22, 2025, the disclosure of which is incorporated herein in its entirety by reference.

### TECHNICAL FIELD

The present disclosure relates to an information processing apparatus.

### BACKGROUND ART

In recent years, with the advancement of generative AI (Artificial Intelligence) technologies, it has become easy to generate data such as audio, images, and text. Along with this, fake data known as so-called deepfakes, including non-existent audio, images, and text, are also being generated, and the misuse of such fake data has become a problem. Therefore, as described in Patent Literature 1, it has become important to perform authenticity determination on data such as audio, images, and text to determine whether or not they correspond to real objects.

Patent Literature 1: WO 2024/116838 A

### SUMMARY

However, simply determining the authenticity of data does not clarify the basis for such determination. Furthermore, in the case of identifying the type regardless of the authenticity of data, the basis for identifying the type is unknown. As a result, a problem arises that it is difficult to utilize the identification result of data.

Therefore, an example object of the present disclosure is to solve the aforementioned problem, that is, it is difficult to utilize the identification result of data.

An information processing apparatus, according to one aspect of the present disclosure, is configured to include
an input unit that inputs, to a model that analyzes data, input data including information based on target data and information based on an identification result of the target data by an identification model, and
an output unit that outputs interpretation data representing an interpretation of an identification result corresponding to the input data, from the model in a plurality of data formats.

Further, an information processing method, according to one aspect of the present disclosure, is configured to include, by an information processing apparatus,
inputting, to a model that analyzes data, input data including information based on target data and information based on an identification result of the target data by an identification model, and
outputting interpretation data representing an interpretation of an identification result corresponding to the input data, from the model in a plurality of data formats.

Further, a program, according to one aspect of the present disclosure, is configured to cause an information processing apparatus to execute processing to
input, to a model that analyzes data, input data including information based on target data and information based on an identification result of the target data by an identification model, and
output interpretation data representing an interpretation of an identification result corresponding to the input data, from the model in a plurality of data formats.

The present disclosure, being configured as described above, makes it easier to utilize the identification result of data.

### BRIEF DESCRIPTION OF DRAWINGS

FIG. 1 is a block diagram illustrating an example configuration of an information processing apparatus according to the present disclosure;

FIG. 2 is a block diagram illustrating an example configuration of an information processing apparatus according to the present disclosure;

FIG. 3 is a flowchart illustrating an example of processing operation by an information processing apparatus according to the present disclosure;

FIG. 4 is a diagram illustrating an example state of processing by an information processing apparatus according to the present disclosure;

FIG. 5 is a block diagram illustrating an example configuration of an information processing apparatus according to the present disclosure;

FIG. 6 is a block diagram illustrating an example configuration of an information processing apparatus according to the present disclosure;

FIG. 7 is a diagram illustrating an example state of processing by an information processing apparatus according to the present disclosure;

FIG. 8 is a block diagram illustrating an example of a hardware configuration of an information processing apparatus according to the present disclosure;

FIG. 9 is a block diagram illustrating an example configuration of an information processing apparatus according to the present disclosure; and

FIG. 10 is a flowchart illustrating an example of processing operation by an information processing apparatus according to the present disclosure.

### EXAMPLE EMBODIMENTS

### First Example Embodiment

A first example embodiment of the present disclosure will be described with reference to the drawings. Note that the drawings may be related to any of the example embodiments.

An information processing apparatus of the present disclosure is, for example, used for performing authenticity determination on target data, that is, speech data, to determine whether the speech is of a real person or of a non-existent person generated by artificial intelligence (AI), that is, fake data (deepfake), and outputting interpretation data of the authenticity determination result. In particular, the information processing apparatus outputs data in a plurality of data formats (a plurality of modalities) such as text, audio, and images, as data explaining the determination of true or false, that is, interpretation data of the authenticity determination result.

As a more specific example, the information processing apparatus in this example embodiment is, for example, an information processing terminal such as a personal computer or a smartphone used by a user. In this case, the information processing apparatus performs authenticity determination of speech data that the user listens to on the information processing apparatus, and outputs interpretation data of the authenticity determination result. Furthermore, when the information processing apparatus has a calling function such as a smartphone, it may perform authenticity determination on speech data from the person to whom the user is talking, and output interpretation data of the authenticity determination result.

Note that the information processing apparatus in this example embodiment is not limited to an information processing terminal used by a user. For example, the information processing apparatus may be an information processing apparatus used by an organization such as a police or a company, an information processing apparatus used in a call center, or the like, and by being used to output interpretation data of the authenticity determination result of speech data as described above, the information processing apparatus can be utilized for crime detection such as impersonation calls.

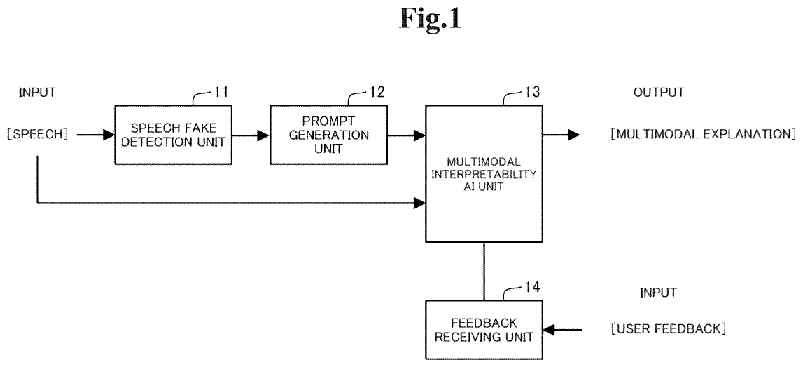

Hereinafter, an example of the configuration and operation of the information processing apparatus in this example embodiment will be described. The information processing apparatus is configured by one or a plurality of information processing apparatuses each equipped with an arithmetic logic unit and a storage device. As illustrated in FIG. 1, the information processing apparatus includes a speech fake detection unit 11, a prompt generation unit 12, a multimodal interpretability AI unit 13, and a feedback receiving unit 14. The functions of the speech fake detection unit 11, the prompt generation unit 12, the multimodal interpretability AI unit 13, and the feedback receiving unit 14 can be realized by the arithmetic logic unit executing programs stored in the storage device to implement the respective functions.

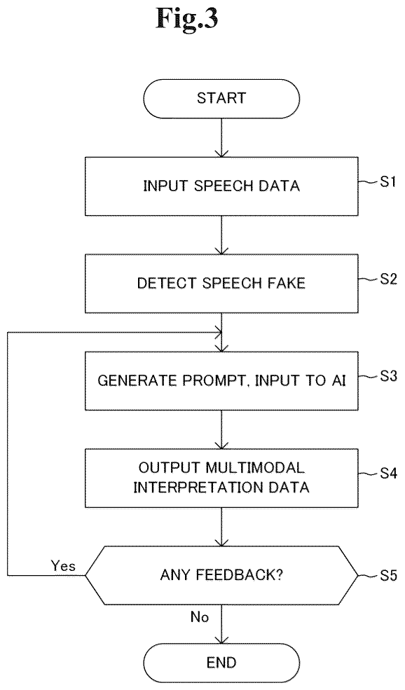

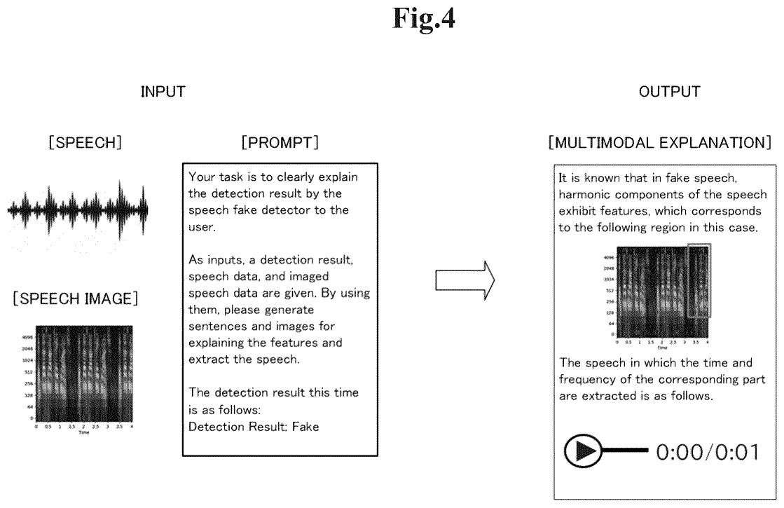

First, the information processing apparatus receives input of speech data and speech image data in which the speech data is converted into an image, as target data to be identified (step S1 in FIG. 3). For example, as illustrated in FIG. 4, the information processing apparatus receives input of speech data consisting of time-series speech waveforms and speech image data in which predetermined feature values of the time-series speech data are converted into an image.

The speech fake detection unit 11 performs authenticity determination to determine whether the speech data that is target data is real data (real) from an actual person's speech or fake data (fake) generated by a generative AI or the like, that is, a speech of a non-existent person (step S2 in FIG. 3). It is assumed that the speech fake detection unit 11 has performed machine-learning using training data consisting of a large number of real data and fake data, and correct data indicating true/false of authenticity determination, and is configured to output an authenticity determination result of the input speech data. Then, the speech fake detection unit 11 outputs the authenticity determination result to the prompt generation unit 12. Note that the authenticity determination result of the speech data may be expressed either as true or false alone, or may be represented by the probabilities (percentages) of true and false respectively.

The prompt generation unit 12 (input unit) generates a prompt (instruction data) that instructs the multimodal interpretability AI unit 13 to output interpretation data according to the content of the authenticity determination result of the speech data, and inputs it to the multimodal interpretability AI unit 13 (step S3 in FIG. 3). At this time, the prompt generation unit 12 generates a prompt instructing to output interpretation data that serves as an explanation by using the speech data and the speech image data, including the authenticity determination result by the speech fake detection unit 11. In accordance with this, the prompt generation unit 12 inputs the speech data and the speech image data to the multi-modal interpretability AI unit 13. It should be noted that either the speech data or the speech image data may be input.

As an example, as illustrated in FIG. 4, the prompt generation unit 12 generates a prompt including the authenticity determination result of the speech data, and inputs it to the multimodal interpretability AI unit 13 together with the speech data and the speech image data. In this example embodiment, a prompt including the authenticity determination result “fake” and requesting interpretation data that serves as an explanation for determining to be “fake” is generated. In this example embodiment, the prompt is designed to request an explanation using the input speech data and the speech image data. The prompt generation unit 12 may generate a prompt that clearly instructs to output interpretation data in a plurality of data formats, that is, multimodal, and input it to the multimodal interpretability AI unit 13.

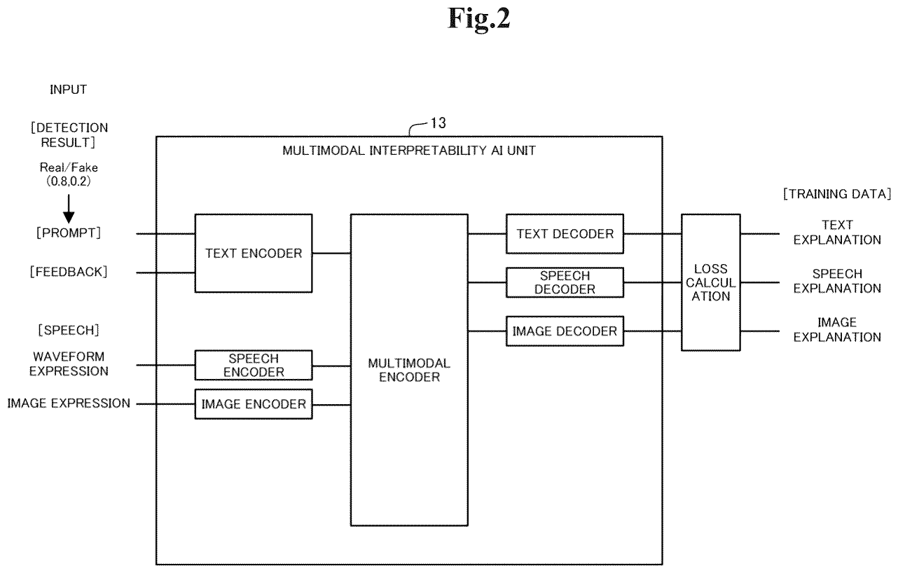

The multimodal interpretability AI unit 13 (output unit) is a model that analyzes input data, and in particular, it is a multimodal model trained by machine-learning to output answers to the input prompts in a plurality of data formats, that is, in a multimodal manner. In this example embodiment, the multimodal interpretability AI unit 13 is configured to output interpretation data in at least two data formats (multimodal) among data formats such as text data, speech data, and image data. Here, the multimodal interpretability AI unit 13 is trained by machine-learning using input data such as the above-described prompts and speech data, and training data in a plurality of data formats corresponding to the interpretation data. For example, as illustrated in FIG. 2, the multimodal interpretability AI unit 13 generates multimodal interpretation data with a multimodal encoder according to input of prompts, speech data, and speech image data encoded by various encoders, then decodes the data by various decoders and output it. Then, the multimodal interpretability AI unit 13 calculates the loss between such an output and prepared training data that is multimodal interpretation data, to machine-learn the multimodal encoding so that the loss is minimized. However, the multimodal interpretability AI unit 13 may be implemented by an existing generative AI.

Then, the multimodal interpretability AI unit 13 outputs interpretation data that is a multimodal explanation in response to an input such as a prompt and speech data (step S4 in FIG. 3). For example, as illustrated in FIG. 4, the multimodal interpretability AI unit 13 outputs interpretation data in a plurality of data formats such as text data, speech data, and speech image data. At this time, the speech data of the interpretation data is data partially extracted from the input speech data, and the speech image data is data in which feature values of the speech, which are the basis for determining to be “fake”, are shown as points or a rectangle on the input speech image data. As described above, the multimodal interpretability AI unit 13 may output interpretation data using the input speech data and speech image data.

The feedback receiving unit 14 (learning unit) receives feedback that is a request regarding the interpretation data, from the user who has obtained the interpretation data output as described above. The feedback has a content that the user requests further explanation for example, and can be the content according to the user's knowledge level (expertise level). As an example, for text data contained in the interpretation data output as illustrated in FIG. 4, such as “harmonic components of the speech exhibit features,” a request for further explanation like “What is the meaning of the features of harmonic components in the speech field?” could serve as feedback.

When the feedback receiving unit 14 receives feedback from the user, it inputs the feedback itself along with input data such as the prompt entered when outputting the interpretation data, to the multimodal interpretability AI unit 13. The multimodal interpretability AI unit 13 then performs machine-learning to output interpretation data that takes the feedback into consideration with respect to the input data. Specifically, the feedback receiving unit 14 prepares interpretation data that is desirable to be output as a response to the request in the feedback, and uses this interpretation data as training data for the input data to perform machine-learning on the multimodal interpretability AI unit 13. As an example, for feedback such as “What is the meaning of the features of harmonic components in the speech field?” in the above-described example, the feedback receiving unit 14 acquires explanatory data regarding “the features of harmonic components in the speech field” from a web server on the Internet or a predetermined database, and performs machine-learning on the multimodal interpretability AI unit 13 using such explanatory data as training data. As a result, when a prompt similar to that mentioned above is input later, the multimodal interpretability AI unit 13 will output interpretation data including an explanation about “the features of harmonic components in the speech field”.

As described above, the information processing apparatus in this example embodiment outputs multimodal interpretation data, allowing the user to obtain the explanation for determining that the speech data is “fake” in a plurality of data formats such as text, speech, and images, making it easier to understand the basis for the determination result. Therefore, even users with limited knowledge in the field of speech processing or in the field of machine-learning models used for determination can understand the basis for the determination result from the interpretation data in various data formats. As a result, the result of authenticity determination on the speech data can be effectively utilized.

Note that the speech fake detection unit 11 and the multimodal interpretability AI unit 13 described above do not necessarily have to be equipped in the information processing apparatus. For example, the speech fake detection unit 11 and the multimodal interpretability AI unit 13 may be equipped in another information processing apparatus connected to the information processing apparatus, and the information processing apparatus may request another information processing apparatus for authenticity determination of speech data to obtain the authenticity determination result, or may request another information processing apparatus for an output of interpretation data by a prompt to obtain multimodal interpretation data.

### Second Example Embodiment

Next, a second example embodiment of the present disclosure will be described with reference to the drawings. Note that the drawings may be related to any of the example embodiments.

An information processing apparatus in this example embodiment has the same configuration as that in the first example embodiment described above. In addition, the information processing apparatus includes the following configuration. Hereinafter, the components different from those described above will mainly be described.

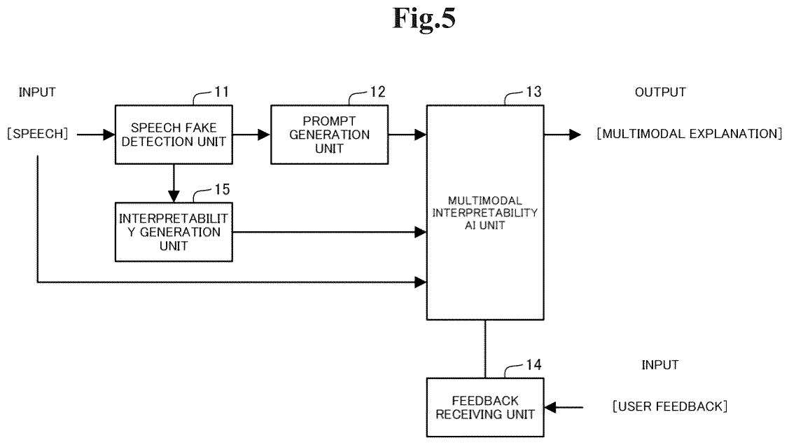

As illustrated in FIG. 5, the information processing apparatus in this example embodiment includes an interpretability generation unit 15 in addition to the configuration described in the first example embodiment. The function of the interpretability generation unit 15 can be realized by the arithmetic logic unit executing a program to implement each function stored in the storage device.

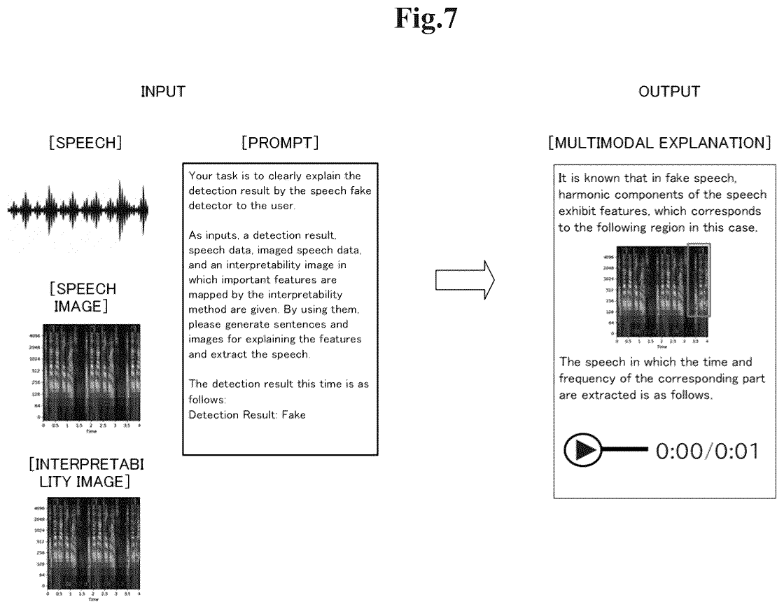

The interpretability generation unit 15 generates interpretability data representing an interpretation of the authenticity determination result of speech data by the speech fake detection unit 11. The interpretability data generated by the interpretability generation unit 15 is data that represents, for example, a content explaining the basis for the determination result. As an example, as illustrated in the “interpretability image” of FIG. 7, the interpretability data is data that shows feature values of a speech serving as the basis for the determination to be “fake”, as points on the speech image data when the authenticity determination result by the speech fake detection unit 11 is “fake”. However, the interpretability generation unit 15 may generate interpretability data having any contents.

Then, the prompt generation unit 12 (input unit) in this example embodiment inputs the interpretability data to the multimodal interpretability AI unit 13, generates a prompt instructing an output of interpretation data based on the interpretability data, and inputs it to the multimodal interpretability AI unit 13. For example, as illustrated in FIG. 7, the prompt generation unit 12 generates a prompt including the authenticity determination result of the speech data and requesting an explanation using speech data, speech image data, and interpretability data that is an interpretability image, and inputs the prompt to the multimodal interpretability AI unit 13 together with the speech data, the speech image data, and the interpretability image.

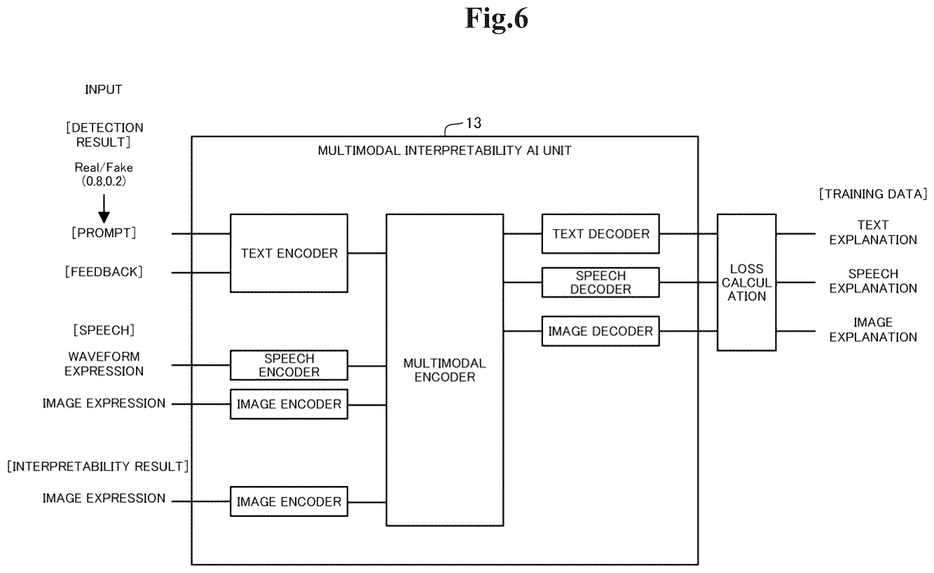

Also, as illustrated in FIG. 6, the multimodal interpretability AI unit 13 (output unit) in this example embodiment is trained by machine-learning using training data in a plurality of data formats corresponding to the interpretation data that can be output, with prompts, feedback, speech data, speech image data, and interpretation data such as interpretability images as inputs. Accordingly, the multimodal interpretability AI unit 13 outputs interpretation data serving as a multimodal explanation, in response to the input of a prompt, speech data, interpretability data such as an interpretability image, and the like. As an example, as illustrated in FIG. 7, the multimodal interpretability AI unit 13 outputs interpretation data consisting of a plurality of data formats such as text data, speech data, and speech image data. At this time, the multimodal interpretability AI unit 13 may output interpretability data in at least one data format using the input interpretability data that is an interpretability image. In the example of FIG. 7, the multimodal interpretability AI unit 13 outputs interpretation data consisting of an image in which an area where feature points appear is marked by a rectangular frame on the interpretability image showing speech feature values as points.

The feedback receiving unit 14 (learning unit) in this example embodiment is configured in the same manner as described above. Therefore, as illustrated in FIG. 7, when the feedback receiving unit 14 receives feedback that is a request for the interpretation data from a user who has obtained the output interpretation data, the feedback receiving unit 14 inputs the feedback to the multimodal interpretability AI unit 13 together with the input data such as the prompt entered when the interpretation data was output. The multimodal interpretability AI unit 13 then performs machine-learning so as to output interpretation data that takes the feedback into account with respect to the input data. As a result, when a prompt that is similar to that described above is input later, the multimodal interpretability AI unit 13 will output interpretation data having the content corresponding to the content of the feedback described above.

As described above, according to this example embodiment, an explanation of the authenticity determination result of the speech data can be obtained in a plurality of data formats such as text, speech, and images, using pre-generated interpretability data. As a result, understanding of the basis for the determination result becomes easier, and the result of the authenticity determination of the speech data can be effectively utilized.

### Third Example Embodiment

Next, a third example embodiment of the present disclosure will be described.

In the information processing apparatus described above, authenticity determination is performed on speech data, and interpretation data with respect to the determination result is output. However, the target data for which authenticity of the like is determined by the information processing apparatus in this example embodiment is not limited to speech data, and may be any type of data. For example, the target data for determining the authenticity or the like may be image data such as still images or moving images, or text data. When the information processing apparatus is an information processing terminal used by a user or an information processing apparatus used by an organization, the information processing apparatus performs authenticity determination on video data or text data viewed or browsed by the user or analyzed by the organization, and outputs interpretation data of the authenticity determination result in a multimodal manner. At this time, the interpretation data may be data that uses image data or text data subjected to authenticity determination or the like.

Furthermore, the information processing apparatus in this example embodiment is not limited to determining the authenticity of target data such as speech data or image data, but may also identify and determine predetermined types of the target data such as speech data or image data. The information processing apparatus may output interpretation data with respect to the determination result of identifying the type of the target data such as speech data or image data in a multimodal manner. For example, the information processing apparatus may identify the age group (for example, teens, twenties, thirties, etc.) of the person who uttered the speech data that is the target data as the type, and output interpretation data with respect to the identified age group in a multimodal manner. Also, for example, when the information processing apparatus handles image data such as X-rays, electrocardiograms, or endoscopic examination images in the medicalcare field, it may identify the type of disease and lesion location from such image data and output interpretation data with respect to the identification result in a multimodal manner. By doing so, it is possible to support decision-making based on the physician's reading.

### Fourth Example Embodiment

Next, a fourth example embodiment of the present disclosure will be described with reference to the drawings. This example embodiment shows the overview of the information processing apparatus and the like described in the above example embodiments. Note that the drawings may be related to any of the example embodiments.

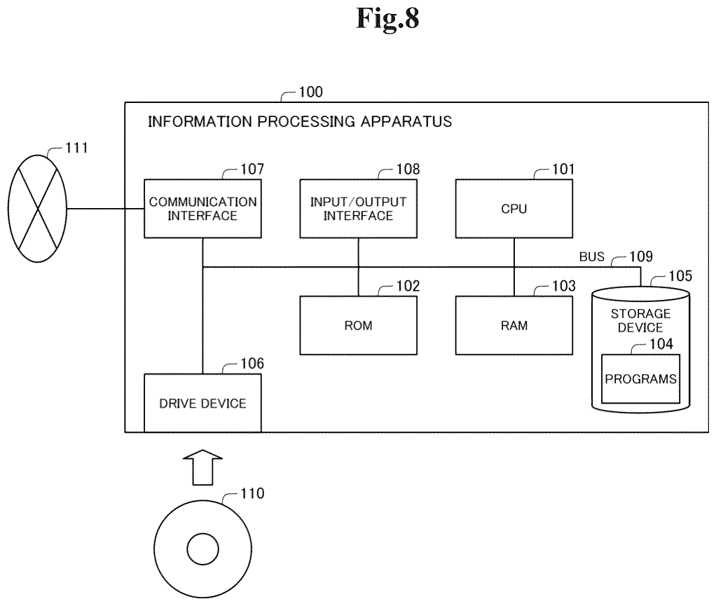

First, the hardware configuration of an information processing apparatus 100 in the present disclosure will be described. The information processing apparatus 100 is configured as a general information processing apparatus, and includes, as an example, the following hardware configuration as illustrated in FIG. 8:
a CPU (Central Processing Unit) 101 (arithmetic logic unit).
a ROM (Read Only Memory) 102 (storage device);
a RAM (Random Access Memory) 103 (storage device);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the component.

FIG. 8 illustrates an example of the hardware configuration of the information processing apparatus 100, and the hardware configuration of the information processing apparatus is not limited to the aforementioned case. For example, the information processing apparatus may be configured of part of the aforementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the CPU.

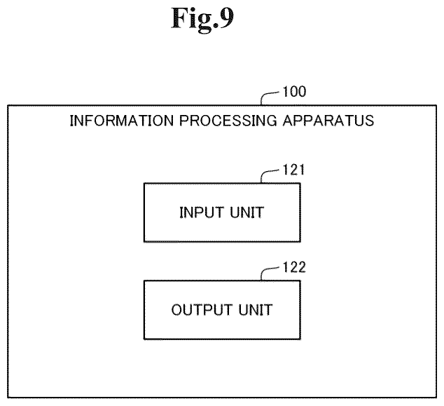

The information processing apparatus 100 can construct and include an input unit 121 and an output unit 122 illustrated in FIG. 9 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or may be stored in advance in the storage medium 110 and read out by the drive device 106 and provided to the CPU 101. However, the input unit 121 and the output unit 122 may be constructed from dedicated electronic circuits for realizing such means.

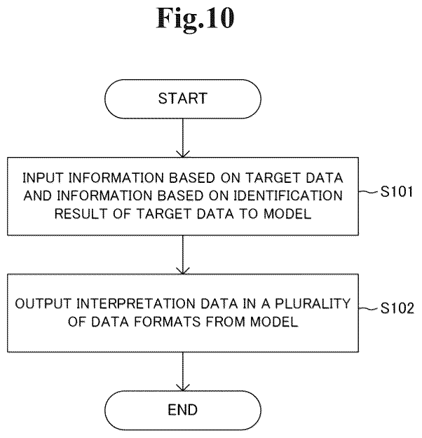

The input unit 121 inputs, to a model that analyzes data, input data including information based on target data and information based on the identification result of the target data by the identification model (step S101 in FIG. 10). The output unit 122 outputs interpretation data representing the interpretation of the identification result corresponding to the input data, from the model in a plurality of data formats (step S102 in FIG. 10).

According to the above configuration, the information processing apparatus 100 inputs, to a model that analyzes data, input data including speech data or speech image data that is target data and an authenticity determination result that is an example of an identification result of the speech data by an identification model, for example. Then, the information processing apparatus outputs interpretation data representing an interpretation of the authenticity determination result that is an example of an identification result corresponding to the input data, from the model in a plurality of data formats such as text, speech, or images. This makes it easy to understand the basis for the identification result from the interpretation data in various data formats, allowing the result of authenticity determination of the speech data to be utilized effectively.

Note that at least one of the functions of the input unit 121 and the output unit 122 may be executed by an information processing apparatus installed and connected anywhere on the network, that is, may be executed by so-called cloud computing.

In addition, the aforementioned programs may be stored using various types of non-transitory computer-readable media and provided to a computer. The non-transitory computer-readable media include various types of tangible storage media. Examples of non-transitory computer-readable media include magnetic recording media (e.g., flexible disk, magnetic tape, hard disk drive), magneto-optical recording media (e.g., magneto-optical disk), a read only memory (CD-ROM), a CD-R, a CD-R/W, and semiconductor memories (e.g., mask ROM, programmable ROM (PROM), Erasable PROM (EPROM), flash ROM, random access memory (RAM)). In addition, programs may be provided to a computer by various types of transitory computer-readable media. Examples of transitory computer-readable media include electrical signals, optical signals, and electromagnetic waves. The transitory computer-readable media may provide programs to the computer via a wired communication channel, such as an electric wire or an optical fiber, or a wireless communication channel.

Although the present disclosure has been described with reference to the example embodiments, the present disclosure is not limited to the example embodiments described above. The configuration and details of the present disclosure can be changed in a variety of ways that those skilled in the art can understand within the scope of the present disclosure. Furthermore, each of the example embodiments described above can be appropriately combined with other example embodiments.

### Supplementary Notes

The whole or part of the example embodiments disclosed above can be described as the following supplementary notes. Below, the overview of the configurations of an information processing apparatus, an information processing method, and a program in the present disclosure will be described. However, the present disclosure is not limited to the configurations described in the following supplementary notes.

Note that the configurations described in supplementary notes 2 to 8 that are dependent on supplementary note 1, and some or all of the functions based on these configurations, can also be dependent on other supplementary notes 9, 10, and 11 in the same dependent manner as with supplementary notes 2 to 8. Furthermore, not limited to supplementary notes 1, 9, 10, and 11, and within the scope of the respective example embodiments described above, some or all of the configurations described as supplementary notes and the functions based on these configurations may be dependent on similar hardware, software, various recording means for recording software, or systems.

### (Supplementary Note 1)

An information processing apparatus comprising:
an input unit that inputs, to a model that analyzes data, input data including information based on target data and information based on an identification result of the target data by an identification model; and
an output unit that outputs interpretation data representing an interpretation of an identification result corresponding to the input data, from the model in a plurality of data formats.

### (Supplementary Note 2)

The information processing apparatus according to supplementary note 1, wherein
the output unit outputs the interpretation data using the information based on the target data in at least one data format, from the model.

### (Supplementary Note 3)

The information processing apparatus according to supplementary note 2, wherein
the input unit inputs, to the model, data representing an interpretation of the identification result of the target data by the identification model as the input data, and
the output unit outputs the interpretation data in which information based on the data representing the interpretation in at least one data format, from the model.

### (Supplementary Note 4)

The information processing apparatus according to supplementary note 1, wherein
the input unit inputs, to the model, instruction data instructing the model to output the interpretation data in a plurality of data formats on a basis of the input data, together with the input data.

### (Supplementary Note 5)

The information processing apparatus according to supplementary note 4, wherein
the input unit generates the instruction data instructing output of the interpretation data corresponding to an identified content of the target data, and inputs the instruction data to the model together with the input data.

### (Supplementary Note 6)

The information processing apparatus according to supplementary note 1, further comprising
a learning unit that inputs, to the model, the input data and a request from a user with respect to the output interpretation data, and trains the model by machine-learning so that the interpretation data corresponding to the request is output from the model.

### (Supplementary Note 7)

The information processing apparatus according to supplementary note 6, wherein
the learning unit inputs, to the model, training data that serves as a response to the request, and trains the model by machine-learning so that the interpretation data based on the training data is output from the model.

### (Supplementary Note 8)

The information processing apparatus according to supplementary note 2, wherein
the input unit inputs, to the model, the input data including at least one of speech data and image data in which the speech data is converted into an image as the information based on target data, and an authenticity determination result as an identification result of the speech data by the identification model, and
the output unit outputs, from the model, the interpretation data in a data format using at least one of the speech data and the image data and in a data format of text data, as the interpretation data with respect to the authenticity determination result of the speech data.

### (Supplementary Note 9)

An information processing method comprising, by an information processing apparatus:
inputting, to a model that analyzes data, input data including information based on target data and information based on an identification result of the target data by an identification model; and
outputting interpretation data representing an interpretation of an identification result corresponding to the input data, from the model in a plurality of data formats.

### (Supplementary Note 10)

A program for causing an information processing apparatus to execute processing to:
input, to a model that analyzes data, input data including information based on target data and information based on an identification result of the target data by an identification model; and
output interpretation data representing an interpretation of an identification result corresponding to the input data, from the model in a plurality of data formats.

### (Supplementary Note 11)

An information processing apparatus comprising:
an input unit that inputs, to a model that analyzes data, input data including information based on target data and information based on an identification result of the target data by an identification model; and
an output unit that obtains interpretation data representing an interpretation of an identification result corresponding to the input data output from the model in a plurality of data formats, and outputs the interpretation data.

### REFERENCE SIGNS LIST

11 speech fake detection unit
12 prompt generation unit
13 multimodal interpretability AI unit
14 feedback receiving unit
15 interpretability generation unit
100 information processing apparatus
101 CPU
102 ROM
103 RAM
104 programs
105 storage device
106 drive device
107 communication interface
108 input/output interface
109 bus
110 storage medium
111 communication network
121 input unit
122 output unit

1. An information processing apparatus comprising:
at least one memory configured to store instructions; and
at least one processor configured to execute instructions to:
input, to a model that analyzes data, input data including information based on target data and information based on an identification result of the target data by an identification model; and
output interpretation data representing an interpretation of an identification result corresponding to the input data, from the model in a plurality of data formats.

2. The information processing apparatus according to claim 1, wherein the at least one processor is configured to execute the instructions to
output the interpretation data using the information based on the target data in at least one data format, from the model.

3. The information processing apparatus according to claim 2, wherein the at least one processor is configured to execute the instructions to:
input, to the model, data representing an interpretation of the identification result of the target data by the identification model as the input data; and
output the interpretation data using information based on the data representing the interpretation in at least one data format, from the model.

4. The information processing apparatus according to claim 1, wherein the at least one processor is configured to execute the instructions to
input, to the model, instruction data instructing the model to output the interpretation data in a plurality of data formats on a basis of the input data, together with the input data.

5. The information processing apparatus according to claim 4, wherein the at least one processor is configured to execute the instructions to
generate the instruction data instructing output of the interpretation data corresponding to an identified content of the target data, and input the instruction data to the model together with the input data.

6. The information processing apparatus according to claim 1, wherein the at least one processor is configured to execute the instructions to
input, to the model, the input data and a request from a user with respect to the output interpretation data, and train the model by machine-learning so that the interpretation data corresponding to the request is output from the model.

7. The information processing apparatus according to claim 6, wherein the at least one processor is configured to execute the instructions to
input, to the model, training data that serves as a response to the request, and train the model by machine-learning so that the interpretation data based on the training data is output from the model.

8. The information processing apparatus according to claim 2, wherein the at least one processor is configured to execute the instructions to:
input, to the model, the input data including at least one of speech data and image data in which the speech data is converted into an image as the information based on the target data, and an authenticity determination result as an identification result of the speech data by the identification model; and
output, from the model, the interpretation data in a data format using at least one of the speech data and the image data and in a data format of text data, as the interpretation data with respect to the authenticity determination result of the speech data.

9. An information processing method comprising, by an information processing apparatus:
inputting, to a model that analyzes data, input data including information based on target data and information based on an identification result of the target data by an identification model; and
outputting interpretation data representing an interpretation of an identification result corresponding to the input data, from the model in a plurality of data formats.

10. The information processing method according to claim 9, further comprising
outputting the interpretation data using the information based on the target data in at least one data format, from the model.

11. The information processing method according to claim 10, further comprising:
inputting, to the model, data representing an interpretation of the identification result of the target data by the identification model as the input data; and
outputting the interpretation data using information based on the data representing the interpretation in at least one data format, from the model.

12. The information processing method according to claim 9, further comprising
inputting, to the model, instruction data instructing the model to output the interpretation data in a plurality of data formats on a basis of the input data, together with the input data.

13. The information processing method according to claim 12, further comprising
generating the instruction data instructing output of the interpretation data corresponding to an identified content of the target data, and inputting the instruction data to the model together with the input data.

14. The information processing method according to claim 9, further comprising
inputting, to the model, the input data and a request from a user with respect to the output interpretation data, and training the model by machine-learning so that the interpretation data corresponding to the request is output from the model.

15. The information processing method according to claim 14, further comprising
inputting, to the model, training data that serves as a response to the request, and training the model by machine-learning so that the interpretation data based on the training data is output from the model.

16. A non-transitory computer-readable medium storing thereon a program comprising instructions for causing an information processing apparatus to execute processing to:
input, to a model that analyzes data, input data including information based on target data and information based on an identification result of the target data by an identification model; and
output interpretation data representing an interpretation of an identification result corresponding to the input data, from the model in a plurality of data formats.
